(19) United States
(12) Patent Application Publication
(10) Pub. No.: US 2011/0069028 A1
(43) Pub. Date: Mar. 24, 2011

(54) METHOD AND SYSTEM FOR DETECTING GESTURES ON A TOUCHPAD

(75) Inventors: Lei LI, Shenzhen (CN); Bangjun He, Shenzhen (CN); Yun Yang, Shenzhen (CN)

(73) Assignee: BYD COMPANY LIMITED, Shenzhen (CN)

(21) Appl. No.: 12/887,894

(22) Filed: Sep. 22, 2010

(30) Foreign Application Priority Data
Sep. 23, 2009 (CN) 200910190704.9

(51) Int. Cl. G06F 3/041

(52) U.S. Cl. 345/173

(57) ABSTRACT

A method for detecting gestures on a touchpad is presented. The method comprises receiving a first contact signal induced by a first contact with the touchpad, detecting a drop in the first contact signal induced by a first lift off the touchpad, recording a first time interval between receipt and drop in the first contact signal, comparing the first time interval to a first reference and a second reference, wherein the first reference is less than the second reference, and the first reference and second reference are predefined, and outputting one of a single-click signal, double-click signal or drag signal.

### CROSS-REFERENCE TO RELATED APPLICATION

This application claims foreign priority benefits under 35 U.S.C. §119 of Chinese Patent Application Serial No. 200910190704.9, filed on Sep. 23, 2009, the content of which is incorporated herein by reference in its entirety.

### TECHNICAL FIELD

The present invention relates generally to a method for sensing a contact with a touchpad, and more particularly to a method for sensing hand gestures on a touchpad.

### BACKGROUND

Although the keyboard remains a primary input device of a computer, the prevalence of graphical user interfaces (GUIs) may require use of a mouse or other pointing device such as a trackball, joystick, touchpad or the like. Operations performed by the pointing devices generally correspond to moving a cursor, making selections, dragging, zoom in/out, rotating or the like.

Touchpads are commonly used on portable electronic devices by providing a panel for user's fingers or other objects to touch or move thereon. Operations on touchpads may be implemented by detecting hand gestures. For example, selections may be made when one or more taps are detected on the touchpads. In addition to selections, moving a selected content from one place to another may be made by dragging a user's finger across the touchpad.

FIGS. 1 to 3 illustrate a method for detecting a single click signal, a double click signal and a drag signal according to the prior art. As shown in FIG. 1, a first signal 102 is induced by contact of a user's finger on the touchpad, and remains until the user lifts the finger off the touchpad. When the touching time t₁ during which the user's finger remains in contact with the touchpad is less than a first reference R1, a first intermediate signal 112 is generated. In an instance in which no signal is detected within a time interval that is less than a second reference R2, a single-click signal is output. On the other hand, in an instance in which a second signal 106 induced by a user's second contact with the touchpad is detected within the time interval R2, as shown in FIG. 2, and the touching time t₂ of the second contact is less than a third reference R3, a second intermediate signal 114 is generated. A double-click signal is then output. When the touching time t₂ of the second contact is greater than the third reference R3, as shown in FIG. 3, a drag signal is output. The method described above may result in a higher possibility of accidental contact of the touchpad, and may further result in performance of erratic operations (e.g., cursor movement) caused by the accidental contact.

### BRIEF SUMMARY

According to one exemplary embodiment of the invention, a method for detecting gestures on a touchpad is presented. The method comprises receiving a first contact signal induced by a first contact with the touchpad, detecting a drop in the first contact signal induced by a first lift off the touchpad, recording a first time interval between receipt and drop in the first contact signal, comparing the first time interval to a first reference and a second reference, wherein the first reference is less than the second reference, and the first reference and second reference are predefined, and outputting one of a single-click signal, double-click signal or drag signal.

According to one exemplary embodiment of the invention, a device for detecting gestures on a touchpad is presented. The device comprising a processor configured to receive a first contact signal induced by a first contact with the touchpad, detect a drop in the first contact signal induced by a first lift off the touchpad, record a first time interval between receipt and drop in the first contact signal, compare the first time interval to a first reference and a second reference, wherein the first reference is less than the second reference, and the first reference and the second reference are predefined, generate a first intermediate signal in an instance in which the first time interval is greater than or equal to the first reference and less than or equal to the second reference, and output one of a single-click signal, double-click signal or drag signal.

According to one exemplary embodiment of the invention, a method for detecting gestures on a touchpad is presented. The method comprises receiving a first contact signal induced by a first contact with the touchpad, recording a threshold time interval until receipt of the first contact signal, comparing the threshold time interval to a predefined threshold reference, and determining a first valid contact signal.

### BRIEF DESCRIPTION OF THE DRAWINGS

The foregoing summary, as well as the following detailed description of the invention, will be better understood when read in conjunction with the appended drawings. The embodiments illustrated in the figures of the accompanying drawings herein are by way of example and not by way of limitation. In the drawings:

FIGS. 1-3 illustrate a method for detecting single click signal, double click signal and drag signal according to the prior art;

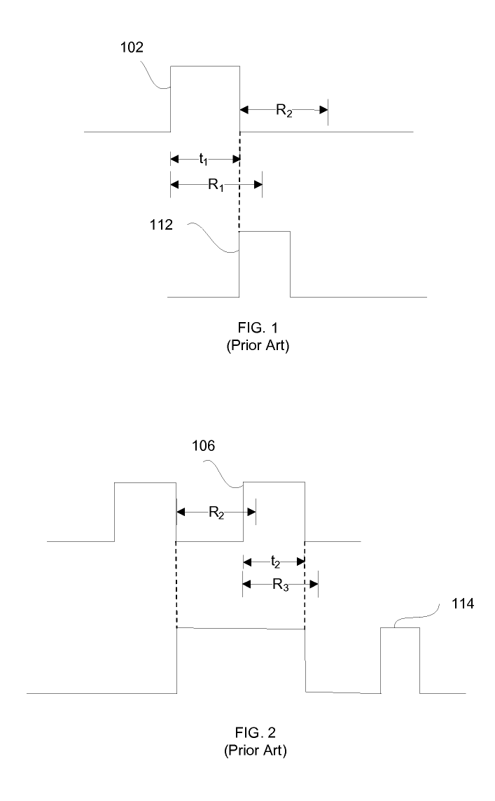

FIG. 4A is a flow chart describing a method for detecting gestures on a touchpad device according to one exemplary embodiment of the present invention;

FIG. 4B is a flow chart describing a method for detecting gestures on a touchpad device according to one exemplary embodiment of the present invention;

FIG. 5 illustrates diagrams of detected signals and a single click signal on a touchpad device according to one exemplary embodiment of the present invention;

FIG. 6 illustrates diagrams of detected signals and a double click signal on a touchpad device according to one exemplary embodiment of the present invention; and

FIG. 7 illustrates diagrams of detected signals and a drag signal on a touchpad device according to one exemplary embodiment of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

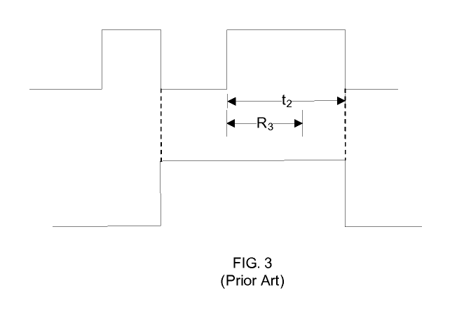

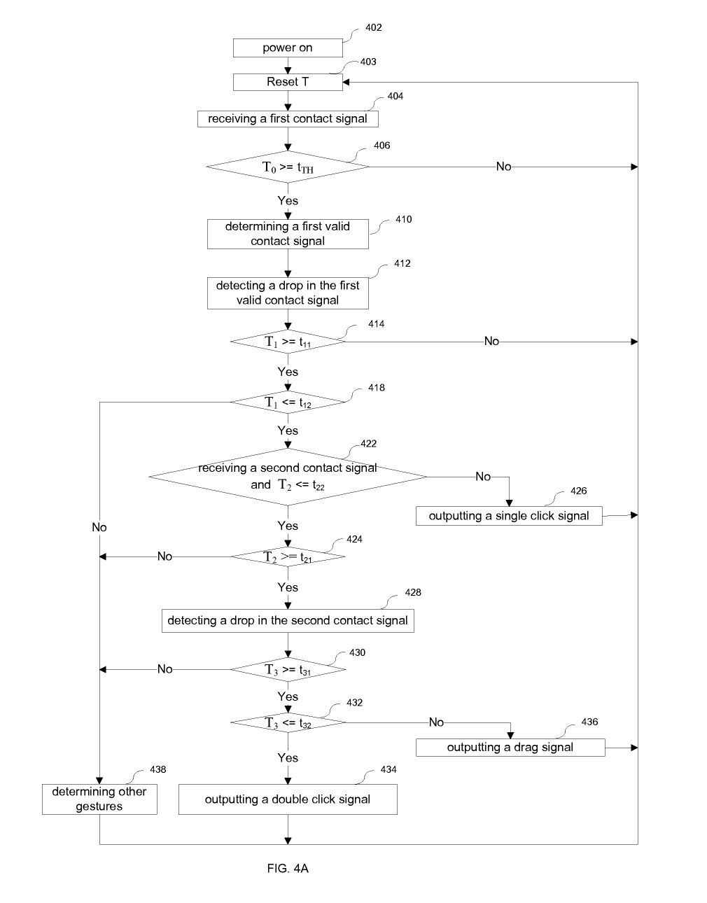

FIG. 4A is a flow chart describing a method for detecting gestures on a touchpad device according to one exemplary embodiment of the present invention (“exemplary” as used herein referring to “serving as an example, instance or illustration”). The detecting method may start when the touchpad is powered on at step 402. A counter is reset and starts to count at step 403. The touchpad may stay in an idle mode until the counter reaches a predefined value, which may be accordingly referred as a “threshold reference” t_{TH}. At step 404, the touchpad may receive a first contact signal at a time in which the counter has a value T₀. The counter may be reset and restart after T₀ is recorded by a processing unit. The first contact signal may be caused by electronic noise, or may be induced by a user's contact. To prevent an unintentional contact on the touchpad from causing performance of erratic operations (e.g., cursor movement), a processing unit embedded in or otherwise in communication with the touchpad may perform comparison functions to compare the value of the counter, T₀, to the predefined threshold reference t_{TH} at step 406. In an instance in which T₀ is less than the predefined threshold reference t_{TH}, the processing unit may determine that the first contact signal is an invalid signal, and reset the counter at step 403. The touchpad will be then awaiting another contact to induce a corresponding contact signal. Steps 403, 404, and 406 may be repeated until the value of the counter on receipt of a contact signal (first valid contact signal), T₀, is greater than or equal to the predefined threshold reference t_{TH} at step 406. In an instance in which no contact signal is received until the counter value reaches a maximum value, the counter may remain the maximum value until a first contact signal is received. In this regard, the counter value T₀ is greater than or equal to the predefined threshold reference t_{TH}. A first valid contact signal may then be determined at step 410. The counter may continue to run, indicating that the user's finger may remain in contact with the touchpad, until the first valid contact signal ceases when the user lifts his/her finger off the touchpad, producing a drop in the first valid contact signal at step 412. The processing unit may record a first time interval T₁ corresponding to amount of time the first contact signal is received (the amount of time the user's finger remains in contact with the touchpad), and reset and restart the counter. The processing unit may compare the first time interval T₁ to a first reference t₁₁ at step 414 to determine if the first time interval is greater than or equal to the first reference t₁₁. In an instance in which the comparison result obtained at step 414 indicates that the first time interval T₁ is less than the first reference t₁₁, the first valid contact signal may be not a desired signal. The detecting method then proceeds back to step 403, to reset the counter awaiting another contact signal.

In an instance in which the comparison result obtained at step 414 indicates that the first time interval T₁ is greater than or equal to the first reference t₁₁, the processing unit continues to compare the first time interval T₁ with a second reference t₁₂ that is greater than the first reference t₁₁ at step 418. The first time interval T₁ that is greater than or equal to the first reference t₁₁ and less than or equal to the second reference t₁₂, compared at steps 414 and 418, may indicate that a valid touch or a real touch is detected. A first intermediate signal is then generated when the counter reaches a third reference time t₂₁. In an instance in which the counter value T₁ is greater than the second reference t₁₂ at step 418, the detected signals may be induced by other gesture that may be determined at step 438.

The processing unit monitors for receipt of a second contact signal from the touchpad at step 422. In an instance in which the processing unit does not receive a second contact signal when the counter reaches a fourth reference time t₂₂ at step 422, or the second contact signal is received after the counter reaches t₂₂, the first intermediate signal is terminated and a single-click signal is output at step 426. The counter is then reset and restarts to run at step 403. On the contrary, in an instance in which the processing unit receives a second contact signal before the counter reaches t₂₂, the processing unit may record a second time interval T₂ as the time between the time the first valid signal ceased and receipt of the second contact signal. The processing unit then compares the second time interval T₂ to the third reference t₂₁ at step 424. In an instance in which the second time interval T₂ is less than the third reference t₂₁, the detected second contact signal may be induced by other gestures which may be judged at step 438.

In an instance in which the second time interval T₂ is greater than or equal to the third reference t₂₁ at step 424 and less than or equal to the fourth reference t₂₂, the processing unit may monitor the second contact signal for a drop in the respective signal at step 428. On detecting a drop in the second contact signal, the processing unit may perform comparison functions to compare a third time interval T₃ to a fifth reference t₃₁ at step 430 and a six reference t₃₂ at step 432. The third time interval T₃ is recorded between receipt and drop in the second contact signal and may indicate a second presence of a finger of the user on the touchpad. In an instance in which the third time interval T₃ is greater than or equal to the fifth reference t₃₁, and less than or equal to the sixth reference t₃₂, the first intermediate signal is terminated, a second intermediate signal is generated and a double-click signal constituted by the first intermediate signal and the second intermediate signal is output at step 434. In an instance in which the third time interval T₃ compared at step 430 is less than the fifth reference t₃₁, the detected signals may be caused by other gestures, which may be determined at step 438. In an instance in which the third time interval T₃ compared at step 432 is greater than the sixth reference t₃₂, a drag signal is output at step 436.

FIG. 4B is a flow chart describing a method for detecting gestures on a touchpad device according to one exemplary embodiment of the present invention. Referring to FIG. 4B, detection and determination of a valid touch and generation of a single-click signal may be performed using a method similar to the method described above. In an instance in which the processing unit receives a second contact signal before the counter reaches the fourth reference time t₂₂ at step 422 and is determined at step 424 to be received after the counter is greater than or equal to the third reference t₂₁, unlike the method described in FIG. 4A, on detecting a drop in the second contact signal, the processing unit may perform comparison functions to compare the third time interval T₃ to the six reference t₃₂ at step 428. In an instance in which no drop in the second contact signal is detected before the counter reaches t₃₂, a drag signal may be out put at step 440. In an instance in which a drop in the second contact signal is detected at step 442 after the counter reaches t₃₂, the drag signal may be terminated by the processing unit at step 444. In an instance in which a drop in the second contact signal is detected after the counter reaches t₃₁ compared at step 430 and before t₃₂ that has been compared at step 428, a double click signal is then output at step 434.

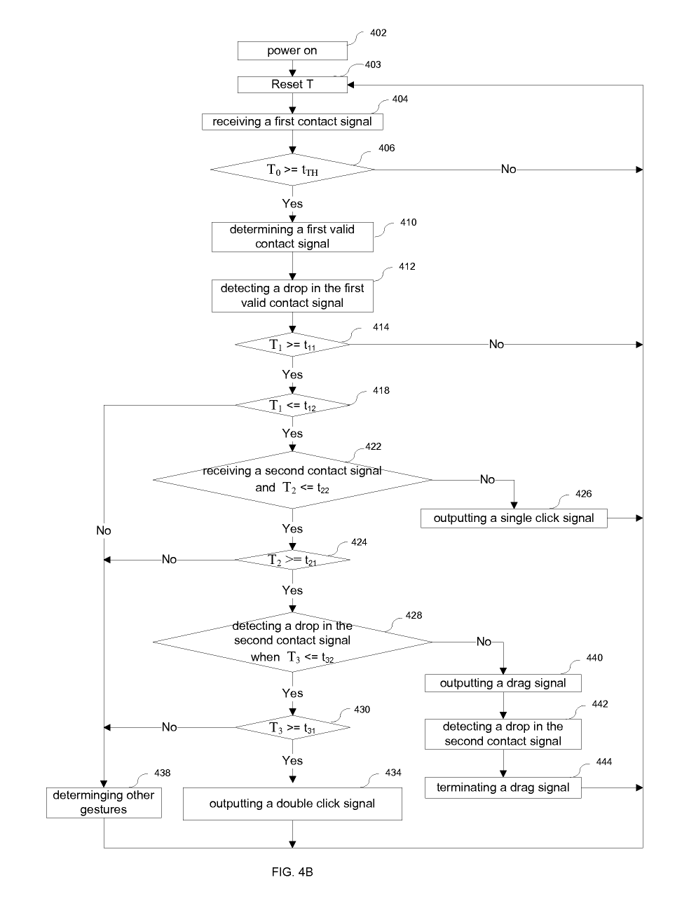

FIGS. 5-7 illustrate diagrams of detected signals and signals output on a touchpad device according to various exemplary embodiments of the present invention. To reduce chances of accidental contact with the touchpad being interpreted as a real “touch,” signals that are received after the touchpad is powered up and before a counter reaches a predefined threshold value t_{TH} may be considered as noises or false signals. In the other situation, amount of time between an invalid signal and receipt of a subsequent received contact signal is also compared to the predefined threshold value t_{TH} to determine if the subsequent received contact signal is “noises” or valid signal. When the counter reaches the predefined threshold value t_{TH}, the touchpad may exit idle mode and enter into operation mode. In the operation mode, the touchpad may be ready to sense signals, process the sensed signals and determine operations to perform (e.g., cursor movements) according to the processing result.

In the exemplary embodiment that is shown in FIG. 5, a first contact signal 502 is received after the counter reaches the predefined threshold value t_{TH}, this signal being the first valid contact signal. When a drop in the first valid contact signal is detected, a first time interval T₁ is recorded between receipt and drop in the first valid contact signal, where this time interval indicates the time a user's finger remained in contact with the touchpad. The processing unit compares the first time interval T₁ to a first reference t₁₁ and a second reference t₁₂. In an instance in which the first time interval T₁ is greater than a first reference t₁₁ and less than a second reference t₁₂, a first intermediate signal 512 is generated when the counter reaches a third reference time t₂₁. In an instance in which the processing unit doesn't receive a second contact signal before the counter reaches a fourth reference time t₂₂, the first intermediate signal is terminated, a single-click signal is output.

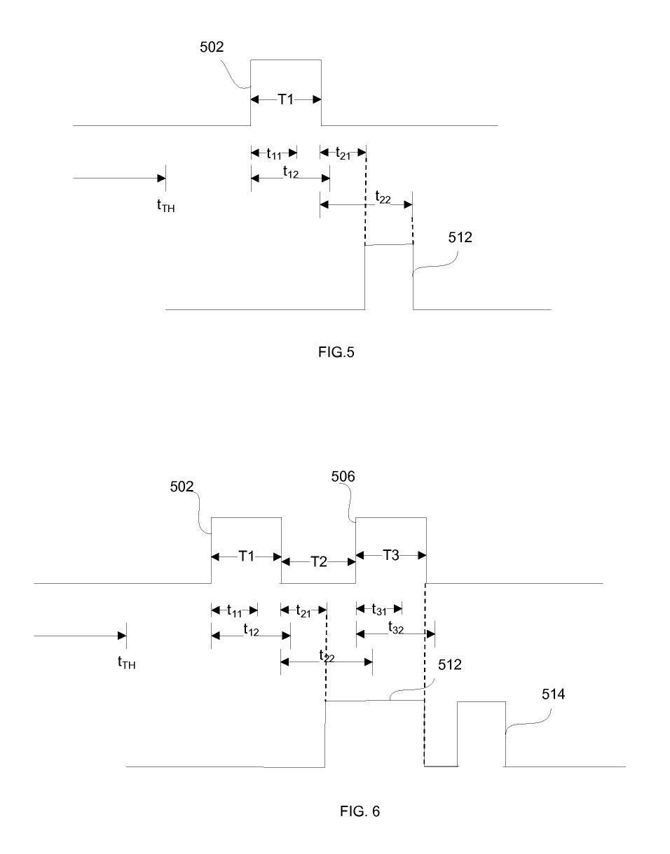

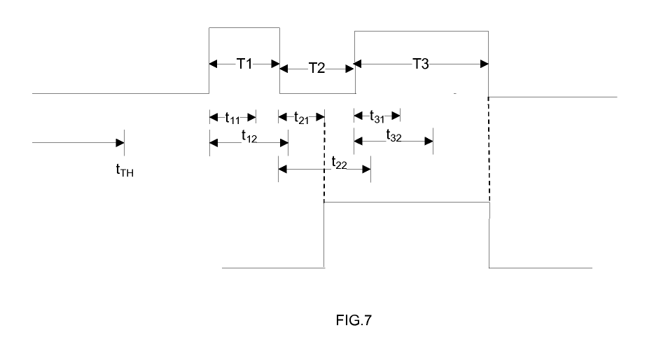

On the contrary, in an instance in which the processing unit receives a second contact signal 506, as shown in FIG. 6, the processing unit records a second time interval T₂, as the time between the time the first valid signal ceased and receipt of the second contact signal 506. The processing unit compares the second time interval T₂ to the third reference t₂₁ and the fourth reference t₂₂. In an instance in which the second contact signal is received before the counter reaches the third reference t₂₁, the detected signals may be induced by other gestures. In an instance in which the second time interval T₂ is greater than or equal to the third reference t₂₁ and less than or equal to the fourth reference t₂₂, this signal being the second valid contact signal. The counter is reset upon receipt of the second contact signal 506 and starts to count until a drop in the second valid contact signal is detected. A third time interval T₃, is recorded between receipt and drop in the second valid contact signal 506, where this time interval indicates the time a user's finger remained in contact with the touchpad. The processing unit compares the third time interval T₃ to a fifth reference t₃₁ and a sixth reference t₃₂. In an instance in which the third time interval T₃ is greater than or equal to the fifth reference t₃₁ and less than or equal to the sixth reference t₃₂, the first intermediate signal 512 is terminated, a second intermediate signal 514 is generated. A double-click signal is then output by the processing unit. To the contrary, in an instance in which the third time interval T₃ is greater than the sixth reference t₃₂, as shown in FIG. 7, a drag signal is output by the processing unit.

The touchpad may include a processing unit and a sensing unit. The sensing unit may sense signals that received on the touchpad. The sensed signals may be received and processed by the processing unit. The sensing unit may be in the form of sensors, sensing layers or the like. The processing unit may be embodied in a number of different manners, such as a CPU (Central Processing Unit), microprocessor, and/or various other processing devices including integrated circuits such as ASIC (Application Specification Integrated Circuit), FPGA (Field Programmable Gate Array) or the like. As will be appreciated, the processing unit may include a counter embodied in the form of a software program or an electronic circuit, e.g., a cyclic counter. In various embodiments, the counter may be reset on receipt and/or drop in a contact signal.

According to one aspect of the present invention, the touchpad may include, for example, a sensing unit and a processing unit. When a user's first finger is resting on the touchpad, the contact with the touchpad may be sensed by the sensing unit, which may be embodied in a number of different manners, such as in the form of a touch-sensitive surface. The processing unit may record time intervals between two received adjacent signals and perform comparison functions to compare the time intervals to predefined references. The processing unit may be embodied in hardware in a number of different manners, such as a CPU (Central Processing Unit), microprocessor, coprocessor, controller and/or various other processing devices including integrated circuits such as ASIC (Application Specification Integrated Circuit), FPGA (Field Programmable Gate Array) or the like. As will be appreciated, the processing unit may include or otherwise be configured to communicate with non-transitory memory, such as volatile memory and/or non-volatile memory, which may store data received or calculated by the processing unit, and may also store one or more software applications, instructions or the like for the processing unit to perform functions associated with operation of the device in accordance with exemplary embodiments of the present invention.

All or a portion of the system of the present invention, such as all or portions of the processing unit, generally operates under control of a computer program product. The computer program product for performing the methods of embodiments of the present invention includes a non-transitory computer-readable storage medium, such as the non-volatile storage medium, and computer-readable program code portions, such as a series of computer instructions, embodied in the computer-readable storage medium.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method of detecting gestures on a touchpad, comprising:
receiving a first contact signal induced by a first contact with the touchpad;
detecting a drop in the first contact signal induced by a first lift off the touchpad;
recording a first time interval between receipt and drop in the first contact signal;
comparing the first time interval to a first reference and a second reference, wherein the first reference is less than the second reference, and the first reference and second reference are predefined; and
outputting one of a single-click signal, double-click signal or drag signal.

2. The method of claim 1, wherein outputting a single-click signal, double-click signal or drag signal includes outputting a single-click signal in the absence of receiving a second contact signal induced by a second contact with the touchpad.

3. The method of claim 1, further comprising:
receiving a second contact signal induced by a second contact with the touchpad;
recording a second time interval between the drop in the first contact signal and receipt of the second contact signal; and
comparing the second time interval to a third reference and a fourth reference, wherein the third reference is less than the fourth reference, and the third reference and fourth reference are predefined,
wherein outputting a single-click signal, double-click signal or drag signal includes outputting a double-click signal or drag signal based on the comparison.

4. The method of claim 3, further comprising in an instance in which the second time interval is greater than or equal to the third reference and less than or equal to the fourth reference:
detecting a drop in the second contact signal induced by a second lift off the touchpad;
recording a third time interval between receipt and drop in the second contact signal; and
comparing the third time interval to a fifth reference and a sixth reference, wherein the fifth reference is less than the sixth reference, and the fifth reference and sixth reference are predefined.

5. The method of claim 4, further comprising in an instance in which the third time interval is greater than or equal to the fifth reference and less than or equal to the sixth reference:
outputting a single-click signal, double-click signal or drag signal includes outputting a double-click signal.

6. The method of claim 4, wherein outputting a single-click signal, double-click signal or drag signal includes outputting a drag signal in an instance in which the third time interval is greater than the sixth reference.

7. The method of claim 1, further comprising:
recording a threshold time interval until receipt of the first contact signal; and
comparing the threshold time interval to a predefined threshold reference,
wherein detecting a drop in the first contact signal, recording a first time interval, comparing the first time interval, and outputting a single-click signal, double-click signal or drag signal occur in an instance in which the threshold time interval is greater than or equal to the predefined threshold reference.

8. A device for detecting gestures on a touchpad, the device comprising a processor configured to:
receive a first contact signal induced by a first contact with the touchpad;
detect a drop in the first contact signal induced by a first lift off the touchpad;
record a first time interval between receipt and drop in the first contact signal;
compare the first time interval to a first reference and a second reference, wherein the first reference is less than the second reference, and the first reference and the second reference are predefined; and
output one of a single-click signal, double-click signal or drag signal.

9. The device of claim 8, wherein the device is further configured to output a single-click signal in the absence of receiving a second contact signal induced by a second contact with the touchpad.

10. The device of claim 8, wherein the device is further configured to
receive a second contact signal induced by a second contact with the touchpad;
record a second time interval between the drop in the first contact signal and receipt of the second contact signal; and
compare the second time interval to a third reference and a fourth reference, wherein the third reference is less than the fourth reference, and the third reference and fourth reference are predefined, wherein the processor is configured to output a double-click signal or drag signal based on the comparison.

11. The device of claim 10, wherein the device is further configured to output a single-click signal in an instance in which the second time interval is greater than the fourth reference.

12. The device of claim 10, wherein in an instance in which the second time interval is greater than or equal to the third reference and less than or equal to the fourth reference, the device is further configured to:
detect a drop in the second contact signal induced by a second lift off the touchpad;
record a third time interval between receipt and drop in the second contact signal; and
compare the third time interval to a fifth reference and a sixth reference, wherein the fifth reference is less than the sixth reference, and the fifth reference and sixth reference are predefined.

13. The device of claim 12, wherein the device is further configured to output a double-click signal in an instance in which the third time interval is greater than or equal to the fifth reference and less than or equal to the sixth reference.

14. The device of claim 12, wherein the device is further configured to output a drag signal in an instance in which the third time interval is greater than the sixth reference.

15. The device of claim 8, wherein the device is further configured to:
record a threshold time interval if the first contact signal is receipted;
compare the threshold time interval to a predefined threshold reference, wherein the processor is configured to detect a drop in the first contact signal, record a first time interval, compare the first time interval, and output a single-click signal, double-click signal or drag signal in an instance in which the threshold time interval is greater than or equal to the predefined threshold reference.

16. A method of detecting gestures on a touchpad, comprising:
receiving a first contact signal induced by a first contact with the touchpad;
recording a threshold time interval until receipt of the first contact signal;
comparing the threshold time interval to a predefined threshold reference; and
determining a first valid contact signal.

17. The method of claim 16, further comprising:
detecting a drop in the first valid contact signal induced by a first lift off the touchpad;
recording a first time interval between receipt and drop in the first valid contact signal;
comparing the first time interval to a first reference and a second reference, wherein the first reference is less than the second reference, and wherein the first reference and the second reference are predefined; and
outputting one of a single-click signal, double-click signal or drag signal.

18. The method of claim 16, further comprising:
receiving a second contact signal induced by a second contact with the touchpad;
recording a second time interval between drop in the first valid contact signal and receipt in the second contact signal;
comparing the second time interval to a third reference and a fourth reference, wherein the third reference is less than the fourth reference, and the third reference and fourth reference are predefined;
detecting a drop in the second contact signal induced by a second lift off the touchpad;
recording a third time interval between receipt and drop in the second contact signal; and
comparing the third time interval to a fifth reference and a sixth reference, wherein the fifth reference is less than the sixth reference, and the fifth reference and sixth reference are predefined,
wherein outputting a double-click signal or drag signal are based on the comparison.

19. The method of claim 18, further comprising outputting a double-click signal in an instance in which the second time interval is greater than or equal to the third reference and less than or equal to the fourth reference, and the third time interval is greater than or equal to the fifth reference and less than or equal to the sixth reference.

20. The method of claim 18, further comprising outputting a drag signal in an instance in which the second time interval is greater than or equal to the third reference and less than or equal to the fourth reference, and the third time interval is greater than the sixth reference.
